(19) United States
(12) Patent Application Publication
(10) Pub. No.: US 2007/0211696 A1
(43) Pub. Date: Sep. 13, 2007

(54) METHOD OF GENERATING NETWORK TRAFFIC

(75) Inventor: Gayle L. Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/685,548

(22) Filed: Mar. 13, 2007

Related U.S. Application Data
(60) Provisional application No. 60/781,792, filed on Mar. 13, 2006.

(51) Int. Cl. H04L 12/66

(52) U.S. Cl. 370/352

(57) ABSTRACT

Generating traffic in a network environment. A traffic generator can be used to record the low level network data that is generated in response to high level user input. The traffic generator can receive instructions that identify when to start and stop recording network instructions. Once started, the high level user input is converted into low level network data and recorded. The recorded low level data thus reflects real usage and can be used to generate virtual traffic. The virtual traffic can be processed such that it represents multiple users. The response of the network or of network components to the virtual traffic can then be monitored and analyzed.

### CROSS REFERENCE TO RELATED APPLICATIONS

This application claims the benefit of U.S. Provisional Application Ser. No. 60/781,792 entitled METHOD OF GENERATING NETWORK TRAFFIC and filed Mar. 13, 2006, which application is incorporated by reference in its entirety.

### BACKGROUND OF THE INVENTION

1. The Field of the Invention

The present invention relates to a method of generating network traffic data. More particularly, the present invention relates to a computer program that generates network traffic data which is sent over a network, methods of generating such traffic data, and methods of using the generated traffic data for analyzing the functionality of a network.

2. The Related Technology

The increasing demand for information communication technologies with faster transmission rates continues to drive the development of new equipment, systems, protocols, and other network functionalities. While network communication technologies continue to develop, implementing new network configurations does not always provide for a smoothly running network. For example, even though a network component may be designed and fabricated for a specific purpose, implementation of the components can often result in the network not functioning as intended. This may be due to various problems that arise during the configuration of the network. As such, network developers may spend a lot of time trying to troubleshoot and debug various network configurations.

In response to the recurring problems that plagued various networks and required tedious troubleshooting, different types of network load generating software programs have been developed. Generally, most troubleshooting programs have been designed to mirror or simulate the exact movements, mouse clicks, keystrokes, icon selections, or other high-level data input in order to precisely simulate the functionality implemented by a user. Accordingly, these programs are quite complex and are expensive to operate and implement. For example, several of these network troubleshooting programs require special classes just to learn how to operate and implement the program. While this may be acceptable for large corporations or other entities specializing in network configurations and/or administration, the costs and complexities of these programs does not provide an avenue for the general public to be able to implement such network troubleshooting.

For example, some types of troubleshooting programs require the operator to understand the underlying protocol for the various functionalities of the network. That is, the operator may need to know and understand the language that the network or various components in the network use in order to communicate over the network.

Also, the operator of these troubleshooting programs may be required to manually change the source identification and/or the target identification for a virtual load using the language supported under the protocol. Additionally, the operator may need to know and understand the protocol in order to properly use the troubleshooting program to generate various handshaking and translation procedures.

In most instances, the operator may need to implement a script or scripting language that will work with the software, equipment, or network to be tested. While many scripting languages used are similar to programming language, this requires the operator to be versed in programming. As such, the requirement for reading and writing scripts can be a sizable task that requires a lot of time. Additionally, requiring the use of a scripting language can lead to many programming mistakes such as syntax errors, slowing down the load generation process, and requiring many hours to debug the troubleshooting procedure. Thus, the troubleshooting procedure can become as problematic as the underlying problem with the network.

Some troubleshooting programs are designed to capture or record the various keystrokes and mouse clicks that the operator implements into a computer system. This requires the troubleshooting program to be configured to understand the graphical interfaces so that it can interpret the keystrokes, mouse movements, and mouse clicks correctly as they relate to the form displayed on the screen. For example, the operator cannot implement a testing procedure that utilizes keystrokes, mouse movements, and mouse clicks in real time. Many programs are not configured to take time into account and result in a simulation with inputs in a rapid succession that do not correlate with the functionality originally obtained. This is because clicking on icons, selecting menus, and other input functions require some time to elapse before the resulting action is displayed on the screen or before the next selection can be performed. When using these programs, the operator may have to go into the script and manually enter the time that it takes to implement a single function. Thus, the more complex the networking function to be tested, the more complex the troubleshooting procedure.

Therefore, it would be advantageous to have software that can perform a troubleshooting function that does not require any additional hardware. Additionally, it would be advantageous to have a troubleshooting program that did not require the operator to have an in-depth understanding of the protocol and the overall functionality of the network in order to implement a troubleshooting procedure. Also, it would be advantageous to have a troubleshooting program that did not require the operator to debug or troubleshoot the troubleshooting program itself, and not require the user to understand the script or program language in order to make the proper changes before the troubleshooting program could be implemented.

### BRIEF SUMMARY OF THE INVENTION

These and other limitations are overcome by embodiments of the invention, which relate to systems and methods for generating network traffic. In one example, traffic data packets are generated on a computer network operating in a network. Data packets transmitted over the network from the computer system are captured. The captured data packets include low level data that corresponds to the high-level data input by a user. After the low-level data is captured, virtual data packets can be generated based on the captured data.

The captured data packets can be processed into virtual data packets that represent multiple users. Then, the network, network components, and the like can be tested using the virtual data. The virtual data thus reflects real user actions (and may include real time delays). Also the virtual data can be used to analyze the impact of multiple users accessing a network resource or destination.

For example, a website (or a network, or a network component such as network attached storage) can be tested by a user who initiates a traffic generator. As the user interacts with the website or browses the website, the traffic generator can record the low level data that is generated from the high level user input and transmitted over the network. After the traffic generator is initiated, the low level data associated with accessing and browsing the website can be recorded. From the recorded data, virtual network data can be generated based on the recorded data. The virtual data can be used to test the functionality of the website. For example, the virtual data can be used to test the responsiveness of a particular webpage of the website in response to multiple requests from multiple virtual users.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by making reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram illustrating an embodiment of an operating environment in accordance with the present invention;

FIG. 2 is a schematic diagram illustrating an embodiment of a computing system;

FIG. 3 is a flow diagram of an embodiment of a method of generating virtual network traffic data;

FIG. 4 is a flow diagram of an embodiment of a method of generating virtual network traffic data with a computer program;

FIG. 5 is a flow diagram of an embodiment of a method of generating virtual network traffic data;

FIG. 6 is a flow diagram of an embodiment of a method of generating virtual network traffic data; and

FIG. 7 is a flow diagram of an embodiment of a method of monitoring a response of a network to virtual users.

### DETAILED DESCRIPTION OF THE PREFERRED EMBODIMENTS

The foregoing problems in the art have been solved by software that can be implemented on a computer system in communication with a network. Additionally, the foregoing problems can be overcome by network traffic generating software that does not require the in-depth knowledge of any particular protocol utilized on the network. Furthermore, the software does not require any modulation or editing of any scripting language, or require any changes to the scripting language to deal with real time functionalities.

An embodiment of the present network traffic generating software enables an operator to select an icon to start a recording function so as to allow the computer system to record the network traffic originated and sent over the network. Alternatively, it records the actions performed by the operator that are held by the computer system before being sent over to the network. More specifically, the software can be configured to record the low-level output of the computer system, where such low-level output is the actual data being sent from the computer over the network. Such low-level data is the network data that arises from the operator implementing keystrokes, mouse movements, or mouse clicks, but is not the actual high-level data of such keystrokes, mouse movements, and mouse clicks.

Accordingly, as used herein, the term “high-level data” is meant to refer to the operator input data that arises from a keystroke, mouse movement, or mouse click, and also includes high-level data generated by the implementation of such input by the operator. That is, the high-level data includes the actual input data from the operator interfacing with a computer program, such as a network browser, that allows the operator to communicate over the network. For example, when an operator uses a program and types information into a form-field or uses a mouse to select and click icons, the resulting data from such inputs is considered to be high-level data. However, high-level data is typically not transmitted across the network because such high-level data is in the operating language of the machine and is usually configured, modulated, and/or transformed into low-level data and data packets before being communicated over the network.

As used herein, the term “low-level data” is meant to refer to the form of the data that is placed in packets before being sent over the network or over the Internet. As such, the data packets being sent over the network are comprised of low-level data. While such low-level data is created from the high-level data, it does not include the actual keystroke, mouse movement, or mouse click data generated by the operator. That is, the low-level data is the actual data transmitted over the network.

In one embodiment, the network traffic data is generated using various modes. For example, one mode could be a pass-through mode of generating traffic. In the pass-through mode the operator can instruct the program to begin recording, and then operate or interface with the network in order to perform a particular function. During the pass-through mode, the traffic generating software simply records the low-level data and/or the data packets comprised of the low-level data that are then sent over the network. That is, the pass-through mode actually allows the operator to communicate data over the network to implement a specific function. Thus, the data being transferred from the computer system over the network is the data that is recorded by the traffic generating software.

In one embodiment, the traffic generating software can operate in a capture and hold mode. Such a capture and hold mode can be initiated when an operator selects a record icon and then records the subsequent low-level data generated from the operator input, but that operator input is not actually transmitted over the network. Thus, by the capture and hold mode, the operator can instruct the software to record activities or inputs implemented into the computer system that are not actually transferred over the network.

In any event, when the operator is satisfied that the inputs will generate the desired function on the network, a stop record icon or other stop record selection can be made. The network traffic generator software can then display the various data that the browser or other network program sends over the network. More particularly, the software displays the low-level data in a manner that allows for the operator to interface with a graphical user interface (“GUI”) or other interface in order to identify the various changes to be made to the low-level data or data packets. As such, the operator can interface with the software in a manner that allows for certain data to be selected and randomized, and for other low-level data to be selected to be held constant or not modulated during the traffic generation.

Moreover, the display of low-level data also presents data not entered by the operator. This can include various identification data such as IP address, or other low-level data generated by the computer in response to the functionality implemented by the operator.

In one embodiment, the operator can interface with the software to change or modulate various parameters of the low-level data. This can allow the operator to select certain targets or alter various parameters in order to generate the desired virtual traffic.

In one embodiment, the traffic generator software can allow the operator to clone the low-level data in a manner that simulates a plurality of virtual users. This can include the operator instructing the software to generate a specific number or a random number of virtual users, wherein the virtual users are identified by different IP addresses or other unique identifiers so that the network does not recognize the cloned data to be sent from the same source. As such, the cloned data can be essentially or substantially similar in nature, but have different and unique identifiers, such as separate and distinct IP addresses, so that when the virtual traffic is transmitted over the network, a functionality can be assessed to determine the response to any specific number of users or any volume of data or load placed on the network.

### I. Operating Environment

In one embodiment, the present invention includes an operating environment comprised of a user, computer system, and a network. Accordingly, a user can operate a computer system to generate traffic data that can either be held or sent over the network. The traffic data can be generated by the user operating the computer system in a manner that performs a functionality so that data compiled by the computer system can then be recorded before being sent over the network. An example of an operating environment is described in further detail below.

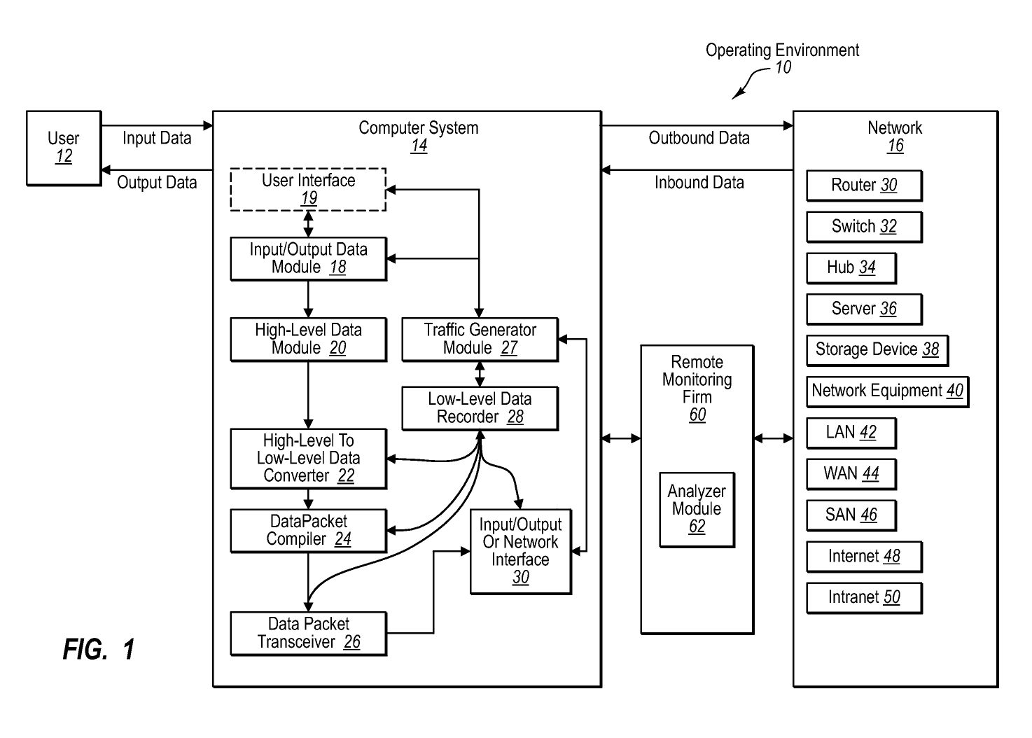

Referring now to FIG. 1, an embodiment of an operating environment 10 is depicted and described in connection with the present invention. Such an operating environment 10, includes a user 12, computer system 14, a network 16, and optionally, a remote monitoring firm 16. The user 12 is able to input data into the computer system 14 and also receive output data from the computer system 14. Examples of input data can include keystrokes, mouse movements, and mouse clicks, whereas output data can include any sounds or visual displays received from a user interface 19.

The input data can be directed from the user interface 19 into an input data module 18. Input data module 18 is a generic term that refers to the hardware and/or software that receives the input data from the user 12. A high-level data module 20 can receive high-level data from the input data module 18. The high-level data module 20 is also a generic term for the hardware and/or software that generates high-level data from the input data.

After the high-level data is compiled in the high-level data module 20, such high-level data is transferred to the low-level data converter 20. As used herein, the high-level to low-level data converter 22 is a generic term for the hardware and/or software that converts high-level data to low-level data. The above identified high-level data can be converted to the low-level data that is generated and transferred across the network. As such, high-level data is converted to low-level data by the use of algorithms, hardware, and/or software.

Accordingly, the low-level data obtained from the data converter 22 is transferred into a data packet compiler 24. Often, when data is transferred over a network, such as the internet, the data is compiled into discreet data packets. The data packet compiler 24 configures the low-level data, which may optionally include some high-level data, into transmittable data packets.

Before data is transferred over the network, the data packets compiled in the data packet compiler 24 are transferred to a data packet transceiver 26. As used herein, the term “data packet transceiver” is meant to refer to the hardware and/or software that transfers data packets over the network. In any event, the data packet transceiver 26 receives the data packets from the data packet compiler 24 and directs the data packets out from the computer system 14 to the network 16 via an input/output or network interface 30. An example of an input/output or network interface 30 can include a modem, Ethernet card, or other hardware and/or software configured to transfer data from the computer system 14 over the network 16.

Concurrently, during the foregoing process of inputting data into a computer system 14 for being converted into low-level data and then compiled into data packets a traffic generator module 27 can be used to record such data. More particularly, the computer system 14 can include a traffic generator module 27 that can be operated by receiving input data from the input data module 18.

The traffic generator module 27 can be in communication with, or include, a low-level data recorder 28. The low-level data recorder 28 can include hardware and/or software configured to capture and/or record low-level data generated or compiled in the computer system 14. As such, when instructed by user 12, the traffic generator module 27 can implement a recording function with the low-level data recorder 28. For example, the low-level data recorder 28 can be in communication with the high-level to low-level data converter 22 so as to be capable of recording the low-level data generated and/or translated therein.

In an alternative embodiment, the low-level data recorder 28 can be in communication with the data packet compiler 24. When the data packet compiler 24 compiles the low-level data, the low-level data recorder 28 can then record such data. In another alternative, the low-level data recorder 28 can be in communication with the data packet transceiver 26. In this embodiment, the low-level data recorder 28 can record the data as it is being passed through the transceiver 26. This can include data entering, within, or leaving the data packet transceiver 26. In any event, the low-level recorder 28 can record the low-level data and/or the data packets that have been generated by the data packet compiler 24.

In yet another embodiment, the low-level data recorder 28 can be in communication with the input/output or network interface 30. In this embodiment the low-level data recorder 28 can capture the data as it is being passed from the computer system 14 onto the network 16. As such, the low-level data recorder 28 can record the outbound data such as the data packets which can include the low-level data.

In any event, the low-level recorder 28 can be configured to operate within the computer system 14 in the manner that allows for the low-level data and/or the data packets to be recorded before they are passed to the network 16.

In the alternative, the low-level data recorder 28 can record such low-level data and/or data packets in a hold manner which generates such data to be transferred to the network 16, but has not yet been transferred to the network 16. As such, instead of the input/output or network interface 30 passing data packets and/or low-level data over the network 16, data can be simply generated for such a purpose, but not actually transferred over to the network.

Additionally, the traffic generator module 27 can be in communication with the input/output or network interface 30 so that the traffic generator module 27 is notified when data is being transmitted from the computer system 14 to the network 16. As such, this information can be provided to the user 12 so that data can be input into the computer system 14 to generate the type of data the user 12 desires to be used for testing the functionality of the network 16.

In another embodiment, the traffic generator module 27 can receive low-level data obtained by the low-level data recorder 28 so that virtual traffic data can be generated. Accordingly, the traffic generator module 27 can include the hardware and/or software for generating virtual network traffic data from the low-level data previously recorded. As such, implementation of a traffic generator functionality within the traffic generator module 27 can include the user 12 interfacing with a user interface 19 and inputting data into the input/output module 18. Such input data can be configured to instruct the traffic generator module 27 to generate traffic to test the network 16.

Additionally, the user 12 can instruct the traffic generator module 27 as to the number of virtual users, the amount of network traffic data associated with such virtual users, and the load to be placed on the network generated by the various virtual users and virtual traffic data created by the network traffic generator module 27. As such, varying loads of virtual network traffic data can be generated within the traffic generator module 27.

After generating virtual traffic, the traffic generator module 27 can transmit the virtual traffic data over the network 16. As such, the virtual network traffic data can be passed over the network 16 and through the associated equipment or components in order to test the functionality of the network and/or the functionality of specific equipment or components within the network. The virtual network traffic data can be configured to implement substantially the same functionality as was performed by the user 12 and/or recorded by the low-level data recorder 28.

More generally, in another embodiment the virtual network traffic data can be configured so as to test the total functionality of a LAN 42, WAN 44, SAN 46, Internet 48, and/or intranet 50. As the virtual network traffic data is passed over the network 16, the functionality of LAN 42, WAN 44, SAN 46, Internet 48 and intranet 50 can be assessed. Accordingly, such networks can be tested for their response to a large volume of virtual users and/or a large volume of data per user in order to determine whether or not the network setup functions as desired.

The virtual network traffic data can be configured to assess the functionality of the network equipment such as a router 30, a switch 32, hub 34, server 36, network storage device 38, or other network equipment 40. When the virtual network data is passed over the network through the foregoing equipment, the functionality of the overall network, including the functionality of such equipment can be tested in response to the load generated by the virtual network traffic data. For example, when the virtual network traffic data is configured to be directed from a plurality of virtual users, which can include different IP or sources of load origination, toward a single recipient, the router 30, switch 32, hub 34, and server 36 can be tested to assess the ability of such equipment to respond to a large number of virtual users attempting to send data. Alternatively, the virtual network traffic data can be configured to identify all such traffic to be generated from a single virtual user to be transferred to a plurality of recipients.

Additionally, various other configurations of virtual network traffic data can be generated and transferred over the network 16 to assess various functionalities of the foregoing types of equipment as well as other equipment that can exist on a network.

In another embodiment, a remote monitoring firm 60 can be in communication with the computer system 14 and/or the network 16. As such, the remote monitoring firm 60 can be notified by the user 12 before a network testing functionality is implemented. The remote monitoring firm 60 may monitor the virtual network traffic data being transferred from the computer system 14 and/or monitor the network traffic data as it is being passed over the network 16.

In one embodiment, the remote monitoring firm 60 can be notified by the user 12 of the network and/or identify the type of equipment that will be tested. While testing the network, the remote monitoring firm 60 can monitor the functionality of such network and/or associated equipment to determine whether or not there are any problems with the network configuration. Also, the remote monitoring firm 60 can utilize an analyzer module 62 to determine whether or not the network and/or components function correctly. This can include processing the data through a protocol analyzer, bit error rate tester (“BERT”), generator, jammer, or any other well-known monitoring modules or tools.

While a general operating environment of the present invention has been described above, other configurations can be implemented within the scope of the invention. As such, the foregoing operating environment 10 is provided as an example of a configuration where a user can record the low-level data to be transferred over the network in order to identify whether or not the network can function in response to various numbers of virtual users as well as various amounts or loads of virtual network traffic data.

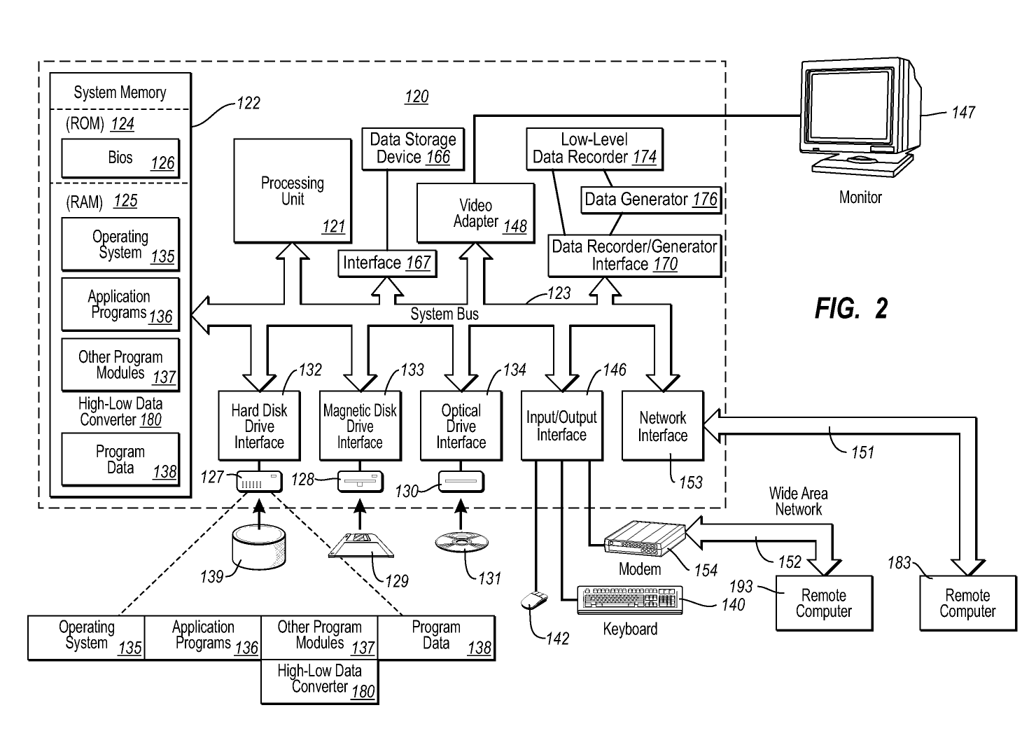

FIG. 2 and the following discussion are intended to provide a brief, general description of a suitable computing environment in which the invention may be implemented. Although not required, the invention can be implemented in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference now to FIG. 2, an example of a general-purpose computer system 120 for implementing the invention is depicted. Such a general-purpose computer system 120 can include a processing unit 121, a system memory 122, and a system bus 123 that couples various system components including the system memory 122 to the processing unit 121. The processing unit 121 can execute computer-executable instructions designed to implement features of the computer system 120, including features of the present invention. The system bus 123 may be any of several types of bus structures including a memory bus or memory controller, a peripheral bus, and/or a local bus using any of a variety of bus architectures.

The system memory includes read only memory (“ROM”) 124 and random access memory (“RAM”) 125; however, other types of memory can be used such as EPROM, EEPROM, and the like. A basic input/output system (“BIOS”) 126, containing the basic routines that help transfer information between elements within the computer system 120, such as during start-up, may be stored in the ROM 124. Additionally, various other types of data can be stored within the ROM 124.

The computer system 120 may also include a magnetic hard disk drive 127 for reading from and writing to a magnetic hard disk 139; a magnetic disk drive 128 for reading from or writing to a removable magnetic disk 129; and an optical disk drive 130 for reading from or writing to a removable optical disk 131, such as, for example, a CD-ROM, DVD-ROM, or other optical media including magneto-optical media. Also, the computer system 120 includes a generic data storage device 166, which can be any type of data storage device. In any event, the magnetic hard disk drive 127, magnetic disk drive 128, optical disk drive 130, and/or generic data storage device 166 are connected to the system bus 123 by hard disk drive interface 132, magnetic disk drive-interface 133, optical drive interface 134, and generic data storage device interface 167, respectively. The drives and their associated computer-readable media provide nonvolatile storage of computer-executable instructions, data structures, program modules, and other data for the computer system 120. Although the example environment described herein employs a magnetic hard disk 139, removable magnetic disk 129, removable optical disk 431, and generic data storage device 166, other types of computer readable media for storing data can be used, including magnetic cassettes, flash memory cards, digital versatile disks, Bernoulli cartridges, RAMs, ROMs, and the like as well as any future developed data storage device.

Program code means comprising one or more program modules may be stored on hard disk 139, magnetic disk 129, optical disk 131, ROM 124, RAM 125, and/or generic data storage device 166, including an operating system 135, one or more application programs 136, other program modules 137, high-to-low level data converting programs 180, and program data 138.

A user may enter commands and information into computer system 120 through keyboard 140, pointing device (mouse) 142, or other input devices (not shown), such as, for example, a microphone, joy stick, game pad, scanner, or the like. These and other input devices can be connected to the processing unit 121 through input/output interface 146 coupled to system bus 123. Input/output interface 146 logically represents any of a wide variety of different interfaces, such as, for example, a serial port interface, a PS/2 interface, a parallel port interface, a Universal Serial Bus (“USB”) interface, or an Institute of Electrical and Electronics Engineers (“IEEE”) 1394 interface (i.e., a FireWire interface), other interfaces, or may even logically represent a combination of different interfaces.

A monitor 147 or other display device is also connected to the system bus 123 via a video interface 148. The monitor 147 can display a GUI. Speakers or other audio output devices (not shown) can also be connected to system bus 123. Other peripheral output devices (not shown), such as, for example, printers, can also be connected to computer system 120.

The computer system 120 is connectable to computer networks, such as, for example, an office-wide or enterprise-wide computer network, a home network, an intranet, the Internet, WAN, LAN, SAN, wireless network, and the like. This can also include the networks to be tested with the virtual network traffic generated by the traffic data generator software (program data 138) on the computer system 120. The computer system 120 can be any type of computer, computing device, electronic communication device, or other similar workstation that can interface with a network for implementing the virtual network generation methods and processes as described herein. Also, computer system 120 can exchange data with external sources, such as, for example, remote computer systems 183 and 193, remote applications, remote servers, remote security managers, and/or remote databases over such computer networks.

The computer system 120 also includes a network interface 153, through which the computer system 120 receives data from external sources and/or transmits data to external sources. As depicted in FIG. 2, the network interface 153 facilitates the exchange of data with a remote computer system 183 such as various servers or network equipment via link 151. The network interface 153 can logically represent one or more software and/or hardware modules, such as, for example, a network interface card and corresponding Network Driver Interface Specification (“NDIS”) stack. The link 151 represents a portion of a computer network (e.g., an Ethernet segment), and remote computer system 183 represents a node of the computer network that stores and manages application data or any type of data communication.

Additionally, the computer system 120 includes an input/output interface 146, through which the computer system 120 receives data from external sources and/or transmits data to external sources. The input/output interface 146 is coupled to a modem 154 (e.g., a standard modem, a cable modem, or digital subscriber line (“DSL”) modem), through which the computer system 120 receives data from and/or transmits data to external sources. As depicted in FIG. 2, the input/output interface 146 and modem 154 facilitate the exchange of data with a remote computer system 193 via a link 152. The link 152 represents a portion of a computer network, and the remote computer system 193 represents a node of the computer network, which can be hardwired or wireless.

In accordance with the present invention, database applications, message applications, and user-interfaces as well as associated data, including application data, schemas, message items, content, attachments, message silos, document silos, traffic generating software, and queries may be stored and accessed from any of the computer-readable media associated with the computer system 120. For example, portions of such modules and portions of associated program data may be included in operating system 135, application programs 136, program modules 137, and/or program data 138, for storage in system memory 122.

When a user operates the computer system 120 via keystrokes, mouse movements, and mouse clicks, which are considered herein to be high-level data inputs, the corresponding application or program to which the user is interfacing creates high-level data. The high-level data can arise from the user interfacing with a program in a manner that uses the program to implement a certain functionality. In the context of the present invention, when the user interfaces with a computer program that performs a network functionality, such as accessing data from a SAN or a website located on a network server, the data entered into the computers system is high-level data. However, the high-level data is not necessarily in the format for being transferred from the computer system 120 over the network. As such, the high-to-low-level data converter 180, which can include hardware and software, converts the high-level data to corresponding low-level data. Thus, the actual keystrokes and other data entries are converted to low-level data before being transmitted.

Additionally, the computer system 120 can include a data recorder/generator interface 170 in communication with the processing unit 121 via the system bus 123. More particularly, the data recorder/generator interface 170 provides a conduit for data to be accessed by a low-level data recorder 174, and for virtual data generated by a data generator 176.

The low-level data recorder 174 can include any hardware and/or software for recording data that has been generated by the computer system 120 in response to a user interfacing with input device such as the keyboard 140 or mouse 142. A user interfacing with an input device includes the keystrokes entered into the keyboard 140 and mouse movements and mouse clicks with the mouse 142, so as to interface with a user interface such as a GUI. For example, when a user views a monitor 147, a GUI for the corresponding low-level data recorder software and/or data generator software is displayed thereon. As such, the user can identify certain features on the GUI that can be interacted with so as to input data into the low-level data recorder 174 being displayed on the monitor 174. More specifically, when a GUI of the low-level recorder 174 is displayed on the screen of the monitor 147, such a GUI can present source-fields and selectable icons that can receive input from the user inputting keystroke data, mouse-movement data, and mouse-click data into the computer system 120 in order to instruct the operations and functionality thereof.

In any event, the user can interface with the GUI in a manner than enables the low level data recorder 174 to record low-level data as described herein. That is, the low level data recorder 174 does not record the keystroke, mouse movement, mouse click data, or the other high-level data that results therefrom, but does record the resulting low-level data generated by the high-to-low level data converter 180. As such, the low-level data recorder 174 records the actual data that is packaged and transmitted through the network interface 153 or modem 154. Thus, the low-level data recorder 174 records the data comprised of the instruction for implementing a particular functionality on a network. Examples of such functionalities performed by the low-level data include communicating data with a SAN, communicating data with a webpage, communicating data with a server, passing data through a router, switch and/or hub to a specific recipient, and other like network data transmissions and functions.

Additionally, the data generator 176 can include hardware and/or software for generating virtual data from data prepared for being transmitted over a network. That is, the data generator 176 can retrieve the data recorded by the low-level data recorder 174, and generate virtual data from actual data in a manner that prepares the virtual data to implement network functionalities that can be substantially similar to that of the actual data. Also, the data generator 176 can include a GUI for a user to interface therewith in order to identify various parameters of the actual data to be modulated or changed in the virtual data. This can include, for example, identifying a certain number of virtual users so that the data generator 176 prepares virtual data for each virtual user; identifying certain network equipment to receive the virtual data; selecting a certain number of data requests for each virtual user to be sent to certain network equipment; identifying certain data, such as audio files, video files, and the like to be acquired from a certain network equipment or data storage device therein; identifying a certain webpage to be accessed by each virtual user; and other like network functions.

When a mass storage device, such as, for example, the magnetic hard disk 139, is coupled to the computer system 120, such modules and associated program data may also be stored in the mass storage device. This can also include high-to-low level data converter programs 180 and the inventive traffic generator program being stored on the magnetic hard disk 139. In a computer network environment, program modules depicted relative to the computer system 120, or portions thereof, can be stored in the remote memory storage devices, such as, system memory and/or mass storage devices associated with the remote computer system 183 and/or remote computer system 193. Execution of such modules may be performed in a distributed environment as previously described.

Additionally, the computer system 120 can store program initialization applications, network traffic recorder applications, recorded network traffic, traffic generator applications, virtual traffic transmission applications, virtual traffic data, virtual low-level traffic data, virtual data packets, virtual user data, and the like in any of the data storage devices. Also, the computer system 120 can store and/or execute computer-executable instructions that facilitate the recording of network traffic data, generation of virtual network traffic data, and/or transmission of the virtual network traffic data over a network. Moreover, the computer system 120 can store and/or implement various protocols that enable a user select parameters to be changed or modulated in any of the recorded or generated data stored therein before being transferred over the network. Thus, the computer system 120 can be used for implementing or executing any of the network traffic generating files, programs, and/or protocols described herein.

### II. Traffic Data Generating Software and Methods

Embodiments of the current invention can include software or computer executable instructions that can be implemented on a computer system. Computer software in accordance with the present invention can be configured to record network traffic data and generate network traffic data therefrom as well as transfer or transmit such virtual traffic data over a network. As such, examples of various computer software functionalities and the methods of operating will be described in more detail below.

Computer software, which can operate to implement various methods to generate virtual network traffic data, can be in the form of a computer program product for use in a computer system in communication with a network. As such, the computer program product can be useful for implementing a method of generating virtual traffic data. A computer program product can include one or more computer-readable media having restored thereon computer-executable instructions that when executed by a computer processor thereby cause the computer system to perform a sequence of functionalities in order to record network traffic data, generate virtual network traffic data therefrom, and transmit or transfer such virtual traffic data over a network and associated components and equipment. As such, software in accordance with the present invention is presented in terms of the methods and functionalities, which can be performed therewith. That is, the following methods can be performed by using network traffic generating software.

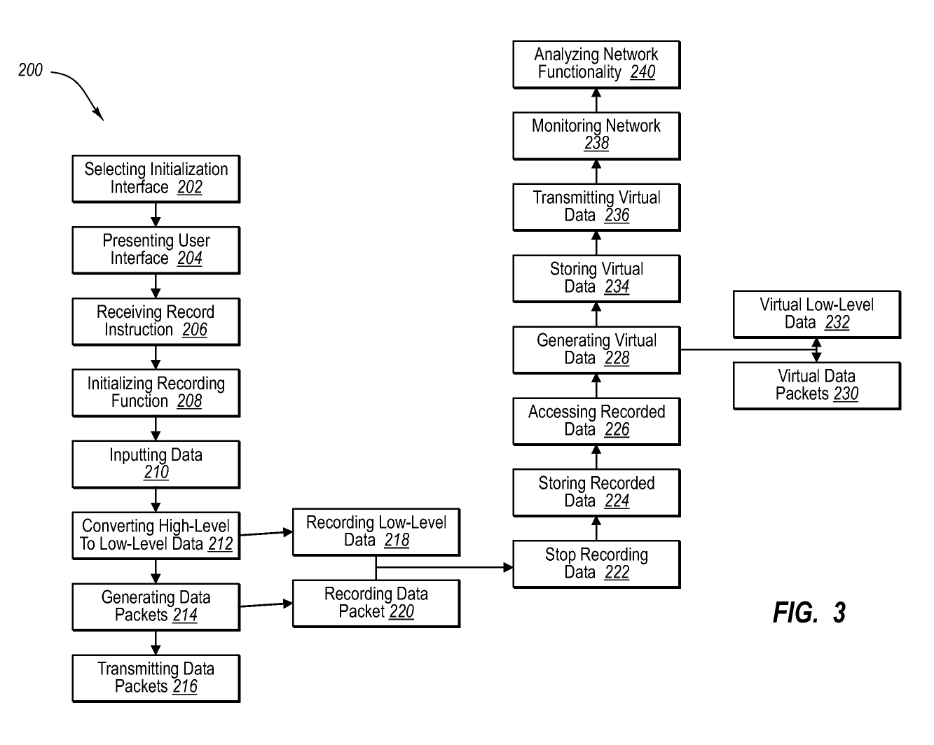

FIG. 3 is a flow diagram illustrating a method 200 for generating virtual traffic data. Such a method 200 for generating virtual traffic data can be implemented with software on a computing system. A user can initialize or initiate the method 200 for generating traffic data by selecting an initialization interface (Block 202), which is usually a selectable icon on a GUI.

Selecting the initialization interface can cause the software to present a user interface (Block 204), which includes a selectable record instruction. Selecting the selectable record instruction results in the software receiving a record instruction from the user (Block 206). The software responds by initializing the recording function (Block 208). When a recording function has been initialized, the user can then begin inputting data into the computer system to be transferred over the network (Block 210).

During the time when information is being input, the computer system can begin converting high-level data into low-level data (Block 212). The computer then begins generating data packets from the low-level data (Block 214). Also, the computer can also begin transmitting the data packets over the network (Block 216).

Concurrently, during the data converting, data packet generating, and data transmitting phases, the computer can be recording the low-level data (Block 218). Alternatively or conjunctively, the computer can also be recording the data packets (Block 220). Accordingly, either the recording of low-level data (Block 218) and/or recording of data packets (Block 220) can be implemented in order to ascertain data relevant to the functionality the user performed over the network.

The recording function can be terminated to stop recording the data (Block 222). Before or after a stop recording data instruction has been implemented, the computer can store the recorded data into a data storage device (Block 224). Subsequently, in order to utilize the recorded data, the data can be accessed from the data storage device (Block 226). The recorded data can then be processed through various algorithms, software, and/or hardware in order to generate virtual data (Block 228). The generated virtual data can be virtual low-level data (Block 232) or virtual data packets (Block 230). In any event, after the virtual data has been generated, it can then be stored in a data storage device (Block 234).

In order to test the network, the virtual data can be transmitted over the network (Block 236). During this transmission, the virtual data simulates the recorded data in a manner that will enable the user to test the network for specific and various functionalities to determine whether or not the network is configured and/or operating correctly. The user or a remote monitoring firm can then monitor the network functionality (Block 238). During such monitoring, the user and/or remote monitoring firm can analyze the various functionalities of the network and the equipment thereof in order to see if the network is functioned properly (Block 240). Such an analysis of the network functionality can include the use of various analytical methods, modules, or procedures in order to determine whether or not the network or its discrete equipment or components are operating correctly.

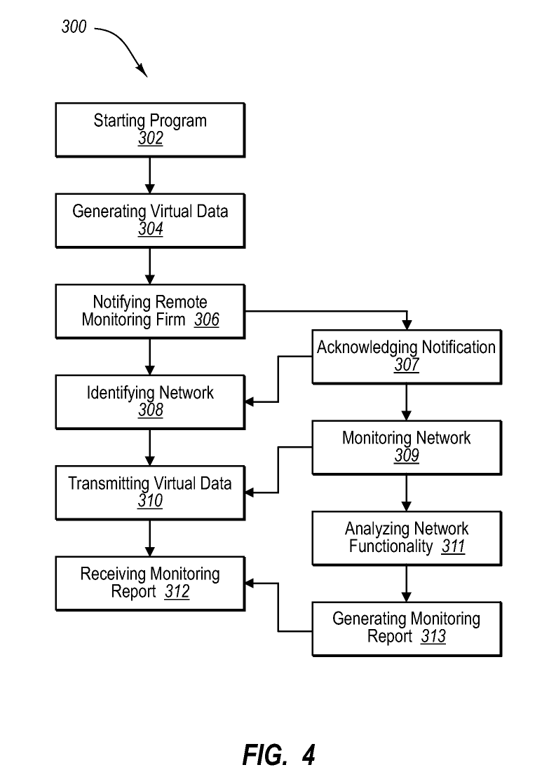

FIG. 4 is a flow diagram illustrating an embodiment of a method 300 for generating network traffic data. Such a method 300 can be implemented by operating computer software configured for generating network traffic data. The method 300 can be initialized by starting the computer software (Block 302).

After the software is running on the computer system, virtual data is generated (Block 304). Such virtual data generation can be performed as described herein.

Before the network test is initiated, a remote monitoring firm is optionally notified of the network test that will be implemented and use the generated virtual data (Block 306). After such notification is sent to the remote monitoring firm, the remote monitoring firm then acknowledges the notification (Block 307). At any point before the virtual data is actually sent over the network, the specific network and associated functionality, which includes the network equipment and software on the network, is identified to the remote monitoring firm (Block 308).

Testing the network with virtual network traffic data includes transmitting the virtual data over the network (Block 310). During this time, the remote monitoring firm is monitoring the network functionalities (Block 309). As such, the remote monitoring firm can collect data that relates to the functionality of the network so that it can be properly analyzed. This includes data for determining whether or not the network was functioning properly, and/or whether or not the equipment could handle the virtual network traffic data.

Subsequently, after the test is complete and the virtual data is no longer being transferred across the network, the remote monitoring firm analyzes the network functionality (Block 311). Such an analysis of the network functionality can include the use of various network diagnostic devices that process the data acquired from the functionality of the network. This can include processing the data through a protocol analyzer, bit error rate tester (“BERT”), generator, jammer, or any other well-known monitoring modules or tools.

In any event, after an analysis of the network functionality has been completed, a monitoring report is generated (Block 313). Such a monitoring report can identify the various functionalities of the network and include a determination of whether or not the network is functioning correctly. Also, the monitoring report can include various instructions or other parameters that can be modulated or reconfigured to enhance or improve the network functionality. After such a monitoring report has been generated, it can be sent to, and received by, the operator (Block 321) by electronic and/or physical transmission.

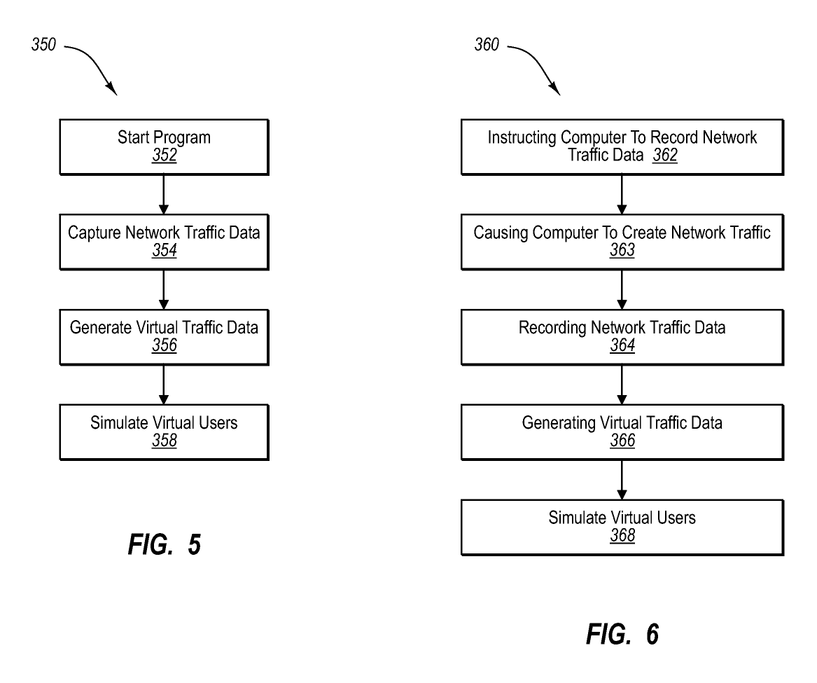

FIG. 5 is a flow diagram depicting the functions of an embodiment of a method 350 for using computer software to generate virtual network traffic data. Such software can present an interface that enables the software to be started (Block 352). After the software has been started, it can cause the computer to capture the network traffic data being generated and transmitted therefrom (Block 354). The capturing of network traffic data can be implemented by a recorded function that records the data being generated. That is, it can capture the actual traffic data being transferred from the computer system over the network, which is low-level data or data packets comprised of low-level data.

After the network traffic data has been captured, it can be utilized to generate virtual traffic data (Block 356). Accordingly, the computer software utilizes the recorded network traffic data in order to generate virtual traffic data. As such, the virtual network traffic data can be considered cloned data that is substantially similar to the network traffic data, but can contain various changes or modulations thereto. Such changes or modulations in the virtual data can include the computer generating a number of virtual users so that each virtual user has distinct identification. Additionally, various other virtual traffic data configurations can be generated.

In any event, after the virtual traffic data has been generated, virtual users are simulated by transmitting the virtual data over the network (Block 358a). By simulating virtual users, the network functionality can be tested in order to determine whether or not it is properly configured to handle the parameters or data load included in the virtual data that has been transmitted by the simulation of virtual users.

FIG. 6 is a flow diagram illustrating an embodiment for method 360 for generating virtual network traffic data. Such a method 360 for generating virtual network traffic data can include instructing a computer system operated by a user to record network traffic data that is generated by the user interfacing with a network program (Block 362). More particularly, instructing the computer to record the network traffic data can include the user selecting a selectable icon or entering some other information into the computer system in response to a GUI.

Additionally, after the computer system has been instructed to record the network traffic data, the user can cause the computer to create network traffic (Block 363). This can be performed by the user operating a network program such as an internet browser or a network browser in order to implement a functionality over the network such as accessing data from a webpage or files from a SAN data storage device. Concurrently, the computer can be recording the network traffic data that has been generated or created by the computer (Block 364). That is, network traffic data can be recorded as the user is inputting data into the computer system, which results in recording the low-level data or data packets that are actually transferred over the network.

After the actual network traffic data has been recorded, the virtual network traffic data is generated (Block 366). Generating virtual network traffic data can provide the types of network traffic data for testing the functionality of the network.

After the virtual network traffic data is generated, the functionality of the network is tested by simulating virtual users (Block 368). That is, a simulation of virtual users can be implemented in order to test the functionality response of the network to such simulated virtual users. As such, the functionality of the network can be monitored during such a simulation of virtual users in order to determine whether or not the network is functioning correctly.

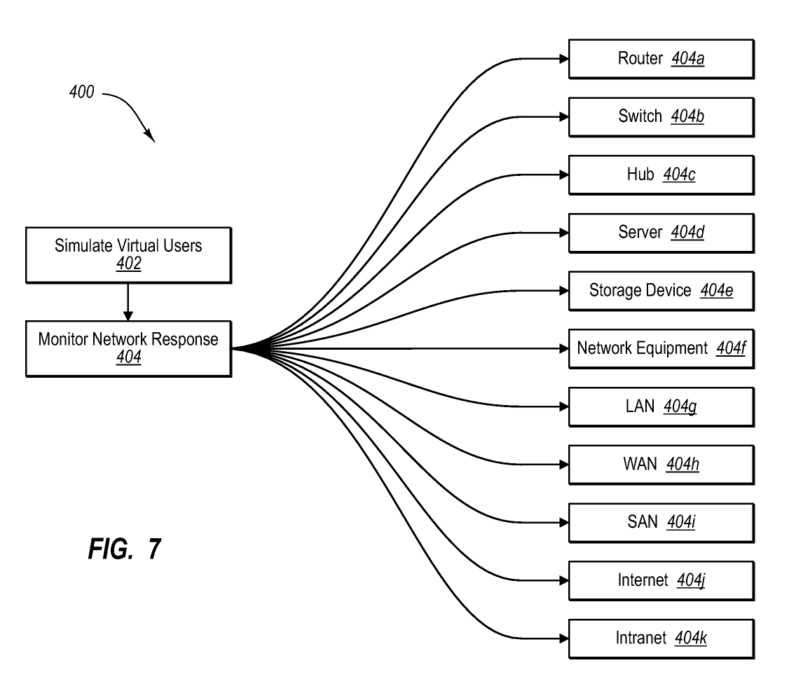

FIG. 7 is a flow diagram depicting an embodiment of a method 400 for analyzing the response of a network to a volume of network traffic. The method can be implemented with software, as described above.

Accordingly, the method 400 includes simulating a plurality of virtual users (Block 402). Such a simulation of a plurality of virtual users can be performed by sending virtual traffic data over a network. That is, the simulation is implemented by transmitting at least one virtual data packet for each virtual user over the network. Accordingly, each of the virtual data packets associated with a virtual user can have a unique identifier and be comprised of low-level data and/or low-level data packets. The simulation can operate in a manner that transfers virtual data over a network so that the response of the network can be monitored.

A virtual traffic transmission may include software that functions similar to a router for responding to multiple virtual user requests and responses to those requests by the network. Thus, a virtual traffic transmission application would include a virtual handler. In an actual network, multiple virtual host IPs are created so that replies can e sent back to the correct host. Because in the case of the virtual traffic application they are all the same host, the different port ID lets the virtual handler know which virtual traffic stream the reply is for.

During and/or after the virtual users are simulated, the associated network response is monitored (Block 404). As such, a user or remote monitoring firm can monitor the response of the network to the plurality of virtual users and associated virtual data that is transmitted over the network.

In one embodiment, monitoring the network response 404 can include monitoring a router (Block 404a), switch (Block 404b), hub (Block 404c), server (Block 404d), storage device (404e), and/or other network equipment (Block 404f). As such the various types of network equipment that comprise the network can be monitored in order to make sure the entire network is operating and functioned properly. Also, this monitors the software, firmware, and/or other types of programs that operate on the network. When network equipment is not functioning properly, the equipment may need to be replaced, repaired, or updated so that the proper functionality can be implemented.

In another embodiment, monitoring the network response 404 can include monitoring various types of networks. This can include monitoring the response of a LAN (Block 404g), WAN (Block 404h), SAN (Block 404i), Internet (Block 404j), and/or intranet (Block 404k). Accordingly, any of these types of networks can be monitored in order to determine whether or not they are functioning properly. More particularly, the functionality of such networks can be monitored by monitoring the various network equipment described in connection herewith.

In one embodiment, the computer software is a stand-alone program that can run on the computer system in concert with another program, such as a network browsing or exploring program. That is, when a user would like to create virtual network traffic data, the traffic generating program can be executed and run on the computer system along with the network program. Accordingly, when the user operates the network program to implement a functionality similar to a desired test functionality, the traffic generating program can be running concurrently to record the low-level data generated by use of the network program. Thus, the traffic generator program can operate so as to monitor and record the data generated by another program so that this data can be utilized in preparing virtual data.

In one embodiment, the computer software for generating network traffic data is a plug-in for another program. For example, the plug-in can be configured to operate with a network browsing or exploring program, which searches for data, accesses data, and retrieves data from the network. Examples of network exploring programs are those which can operate on a LAN, WAN, SAN, intranet, and the Internet as well as other types of networks. As such, when a network browsing or exploring program is operated on a computer system, such a program can be compatible and operate with the plug-in. This enables the plug-in to operate through or with the network exploring program. Thus, the plug-in can be implemented to record the low-level data generated by the network browsing or exploring program and transmitted across the network.

When generating network traffic, the resources available to a given user can vary and the operating environment can also vary. Embodiments of the invention enable a user that has an existing computer, network card, and real network connection to perform the analyses described herein by generating the necessary network traffic using their existing equipment without requiring the purchase of additional hardware/software solutions.

Embodiments of the invention contemplate different approaches for generating network traffic that account for different environments. In other words, the type of network traffic required, the existing environment, and the context of the network traffic may be considered as the network traffic is generated.

For example, a user may access a network through a service provider that only allows a single online computer. In this case, it is difficult for the user to test the load ability of a web site as the destination for the data returned by the web site is the same for all of the simulated users. This is resolved, in one embodiment, by outsourcing the job of testing the load to an external service that has the bandwidth needed to make the load test effective. The user can still generate and record the low-level data, but the job of testing the load is performed by the service. The timing could be generated and sent, for example, to the web designer via email and the like. Thus, the traffic generated by the user can be used to obtain the timing or the response of the web site to a given load.

For example, request packets could be captured or recorded when the user presses the record button, then visits the web site in any way such as typing in the URL or by selecting a bookmark. The user then navigates the web site viewing pictures and videos, etc. After navigating the web site, the user presses the stop recording or stop button. Thus, the user recorded actual data as the actual functions were performed. The user has thus captured low-level packets that the network card was sending to a router.

The user can contact the web service or other provider, open a job on his or her account, and send the recorded data to the service. The job description typically indicates how many users, for example, the user wishes to be able to access the web site at any given time. The web service can then send out the recorded data as packet streams where each stream is coded as a different user. Some of the streams are synchronized and other are skewed. The service times the response and sends the report to the user via email, for example.

Alternatively, the user may be permitted to have multiple computers online at the same time. In this case, the online computers can simulate the response to navigational commands by simulating multiple users. More particularly, the software would send multiple request to the web site under test. A local router may be employed such that the requests generated by the user appear to be from different computers. The user can then capture the response to the generated traffic.

In another embodiment, assuming that a user has access to the world wide web site and that the network and subnets are known, the server can be configured to send data to a clear sub net in the server room to test responsiveness.

In another example, the tests can be performed on a SAN in a lab environment. The lab typically provides an appropriate network configuration such as a private sub net for running performance tests and not having to worry about the bandwidth of the network the tests are being performed on as a limiting factor. These considerations, and others, can be implemented in the below examples. Accordingly, the present invention includes, but is not limited to, the software and methods for implementing the following examples.

### EXAMPLES OF EMBODIMENTS OF THE INVENTION

The following examples are “prophetic” examples describing the uses and implementation of embodiments of the present invention. As such, the examples have not been actually performed, but have been contemplated to be capable of being performed with embodiments of the present invention. Further, these examples are illustrative only and are not limiting.

### Example 1

An amateur webdesigner creates a webpage that includes various types of data such as text information, selectable icons, family pictures, home videos, and the like. However, the amateur webdesigner is not sure how the webpage, associated network, and network equipment will handle various levels of traffic visiting the webpage. While the amateur webdesigner does not expect a large volume of simultaneous visitors at anyone one time, a large portion of the family may visit the webpage during the holidays.

The amateur webdesigner uses a computer system to run a web browser and clicks on a selectable icon to open the traffic generator plug-in. The amateur webdesigner then views the GUI for the traffic generator plug-in and clicks on a selectable icon to begin recording the network traffic generated by the web browser. The amateur webdesigner then uses the web browser to view his webpage and download the family pictures and other files by clicking selectable icons. Concurrently, the traffic generator plug-in records the low-level data sent from the computer system over the network to the server or other network equipment and vice versa. After completing the task, the amateur webdesigner clicks a selectable icon on the traffic generator plug-in GUI to terminate the recording functionality.

The amateur webdesigner then clicks a selectable icon on the traffic generator plug-in GUI to generate virtual data from the actual network traffic data. After which, the amateur webdesigner identifies how many virtual users will be created by typing the number into a source-field on the GUI. The traffic generator then generates a set of virtual network traffic data packets for each virtual user in accordance with the amateur webdesigner's parameters. The amateur webdesigner then clicks a selectable icon on the GUI to proceed with generating network traffic, which then transmits the virtual data for each of the virtual users over the network to test the functionality of the webpage, network, and associated network equipment.

In this example, it is likely that the amateur web designer is using a system that has a dynamic IP address assigned by his or her service provider. Embodiments of the invention can generate network traffic in different manners based on the resources available to the user. In this example, the amateur web designer may be limited to a single online computer or the user may be permitted to have multiple computers online at the same time. The testing can be implemented as described above, depending on the network environment and what the web designer is allowed by the IP provider, for example.

For instance, one approach is to use a web service as the load of the web designer's site is being tested and the user can only have a single computer online at a time. On the other hand, if the web designer can have multiple computers online at the same time, the user may want to test how the web site responds to navigational commands when multiple users are using the web site. In this case, the web designer can generate traffic representing virtual users. This data can then be captured and responses to threads can be measured.

### Example 2

An experienced webmaster uses a traffic generator plug-in by performing substantially the same acts as described in connection with Example 1; however, various parameters are changed. The parameters that are changed include the type of website and web browser. Accordingly, the website is a commercial website that sells software. As such, the website includes means for viewing the available software, means for selecting the software, means for paying for the software via credit card, and means for identifying where to ship the software. In any event, the webmaster operates the plug-in to record the low-level data sent over the network that arises from using a given web browser to implement various functionalities on the webpage, to generate cloned virtual data for a plurality of virtual users, and simulate the plurality of virtual users concurrently implementing a substantially similar functionality.

### Example 3

A webmaster implements a webpage test as described in connection to Example 2; however, the test additionally includes a remote monitoring firm monitoring and analyzing the webpage and associated network functionality in response to the test. As such, before or after the recording icon is selected, a selectable icon for notifying the remote monitoring firm is clicked, which presents a monitoring GUI. The webmaster then supplies the proper webpage and network indicia into the source-fields to identify when the test data will be recorded, the webpage and hosting network equipment to be tested, the type of virtual data to be generated, and/or other test parameters such as the functionality being tested, webpage configuration, and the like. The remote monitoring responds to the webmaster and identifies that the webpage and associated network will be monitored during the data recording and virtual webpage traffic generation.

Subsequently, the remote monitoring firm monitors the webpage when the data is recorded and/or when the virtual webpage traffic is generated in order to obtain diagnostic data. After which, the remote monitoring firm processes the diagnostic data to determine whether or not the webpage and associated network functioned properly or optimally. Such processing is implementing by processing the diagnostic data through a network diagnostic module to analyze the diagnostic data. The remote monitoring firm then generates a monitoring and/or analysis report, and sends the report to the webmaster.

### Example 4

A developer creates a data storage device that is configured to be implemented into a computer system on a data storage network, such as a SAN. While the data storage device performs well during tests in a computer system, one intended use is to be implemented on a SAN network, which is likely to receive a large traffic load. However, the developer is not sure how the data storage device will function when communicatively coupled with a SAN network and receiving a large volume of consecutive read/write requests.

The developer installs the data storage device on the SAN at a remote location, and uses a computer system to run a SAN browser for accessing various types of data from the data storage device. The developer then clicks on a selectable icon on a GUI to open the traffic generator program, which is a stand-alone program. The developer then views the GUI of the traffic generator program and clicks on a selectable icon to begin recording the SAN network traffic generated by the SAN browser. The developer then uses the SAN browser to download data from the data storage device and upload data thereto. Concurrently, the traffic generator program records the low-level data sent from the computer system over the SAN network to the data storage device and vice versa. After completing the task, the developer clicks a selectable icon on the traffic generator program GUI to terminate the recording functionality.

The developer then clicks a selectable icon on the traffic generator program GUI to generate virtual data from the actual network traffic data. After which, the developer identifies how many virtual users will be created by typing the number into a source-field on the GUI. The traffic generator program then generates a set of virtual network traffic data packets for each virtual user in accordance with the developer's parameters. The developer then clicks a selectable icon to proceed with generating network traffic, which then transmits the virtual data for each of the virtual users over the SAN network to test the response and functionality of the data storage device, which includes the ability to upload and download a large volume of consecutive data requests.

### Example 5

A developer implements a data storage device test as described in connection to Example 4; however, the test additionally includes a remote monitoring firm monitoring and analyzing the data storage device and associated network functionality in response to the test. As such, before or after the recording icon is selected, a selectable icon for notifying the remote monitoring firm is clicked. The developer then supplies the proper data storage device and network indicia into the source-fields to identify when the test data will be recorded, the location of the data storage device, network, other network equipment to be tested, the type of virtual data to be generated, and/or other test parameters. The remote monitoring responds to the developer and identifies that the data storage device and associated network will be monitored during the data recording and/or virtual network traffic generation.

Subsequently, the remote monitoring firm monitors the data storage device and associated network when the data is recorded and/or when the virtual network traffic data is generated in order to obtain diagnostic data. After which, the remote monitoring firm processes the diagnostic data to determine whether or not the data storage device and associated network functioned properly or optimally. Such processing is implementing by processing the diagnostic data through a network diagnostic module to analyze the diagnostic data. The remote monitoring firm then generates a monitoring and/or analysis report, and sends the report to the developer.

### Example 6

A data storage device developer uses a traffic generator program by performing substantially the same acts as described in connection with Example 5; however, various parameters are changed. The parameters that are changed include the traffic generator program being a SAN browser plug-in, and the virtual users are configured to attempt to concurrently download the same data and concurrently upload different and distinct data. Accordingly, the ability of the data storage device to handle a large load of concurrent drive hits by transmitting the virtual data over the SAN to the data storage device is tested by the developer and monitored by the remote monitoring firm.

### Example 7

A network engineer develops and installs a SAN network configuration. While the SAN network performs well during tests on individual network equipment, which includes a SCSI raid, SATA raid, and various equipment that operate under the SCSI protocol or Fibre Channel protocol, the functionality of the entire network needs to be tested before going online. More particularly, it is unknown whether or not the SCSI raid will behave the same or similarly with the SATA raid in response to various read/write requests or other network traffic data. Additionally, the network engineer does not know how the SCSI or SATA command frames operate alone, how they may interact together on the network, or how the translation from the Fibre Channel protocol to the SCSI protocol is performed.

The engineer uses a computer system to run a SAN browser for implementing various SAN network functionalities in order to determine whether or not the SAN network can function as designed. The engineer then clicks on a selectable icon on a GUI to open the traffic generator program, which is a stand-alone program or a plug-in for the SAN browser. The engineer then views the graphical user interface of the traffic generator plug-in and clicks on a selectable icon to begin recording the SAN network traffic generated by the SAN browser. The engineer then uses the SAN browser to download data from the data storage device and upload data thereto as well as communicate data between the SCSI raids and the SATA raids. Concurrently, the traffic generator program records the low-level data sent from the computer system over the SAN network to the SCSI raids, SATA raids, and vice versa. After completing the task, the engineer clicks a selectable icon to terminate the recording functionality.

The engineer then clicks a selectable icon to generate virtual data from the actual network traffic data. After which, the engineer identifies the functionality to be used to test the operation and interoperability of the SCSI raids and SATA raids by inserting the instructional data into source-fields on the GUI. The traffic generator program then generates a set of virtual network traffic data packets to test whether the SCSI raids and SATA raids function correctly with the desired interoperability in accordance with the engineer's parameters. The engineer then clicks a selectable icon to proceed with generating network traffic, which then transmits the virtual data from the computer system over the network, which includes passing data between the SCSI raids and SATA raids. As such, the virtual network traffic data transmitted over the SAN network tests the response and functionality of the SAN network and interoperability of the different types of network equipment as well as interoperability of the different protocols without the engineer knowing the protocols being used or their interoperability.

### Example 8

A network operator upgrades various types of equipment on a network and alters the network system setup. The operator implements a denial-of-service attack (DOS attack), such as a ping of death or teardrop attack, early warning configuration and procedure that is meant to maintain the network integrity in response to a flood of useless traffic that results from such an attack. Also, the operator implements a system configuration and procedure to properly handle load sharing when large traffic loads flood the network.

The operator uses a computer system to run a network explorer with a traffic generator plug-in for passing various types and amounts of network traffic data over the network and upgraded equipment to test the early warning configuration and load sharing. The operator then clicks on a selectable icon to open the traffic generator plug-in after the network explorer is running. The operator then clicks on a selectable icon to begin recording the network traffic generated by the network explorer. The operator then uses the network explorer to pass various types and amounts of network traffic data over the network and upgraded equipment, wherein an amplification of such network traffic data would be similar to a DOS attack. Concurrently, the traffic generator program records the low-level data sent from the computer system over the network and over the upgraded equipment. After completing the task, the operator clicks a selectable icon to terminate the recording functionality.

The operator then clicks a selectable icon to generate virtual data from the actual network traffic data. After which, the operator identifies the magnitude of the virtual network traffic data packets to be generated and passed over the network, which can include clicking a selectable icon that generates virtual data to simulate a DOS attack. The operator then clicks a selectable icon to proceed with simulating a DOS attack, which then transmits the virtual data over the network to test the response and functionality of the network to a DOS attack, which includes providing a DOS attack early warning and proper load sharing.

Such a simulated DOS attack could be executed from a system not on the main network and attacking the internal network at its gateway as if it were coming from the outside, or just after the gateway and the gateway's firewalls to test how the network would respond if the attack got through the gateway without actually interfering with the gateway. Attack tests may be run through the gateway just like normal traffic and could be routed accordingly.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating traffic data packets on a computer system in communication with a network, the method comprising:
capturing at least one data packet transmitted over the network from the computer system, the at least one data packet being comprised of low-level data generated by a user inputting high-level data into the computer system; and
generating at least one virtual data packet from the at least one data packet.

2. The method of claim 1, further comprising presenting a user interface to a user.

3. The method of claim 2, further comprising receiving a record instruction from the user, the record instruction initializing a recording function of the low level data.

4. The method of claim 3, further comprising receiving high level data as user input, the high level data including mouse input and keyboard input.

5. The method of claim 1, further comprising converting the high level data to low level data.

6. The method of claim 5, wherein capturing at least one data packet further comprises recording the low level data.

7. The method of claim 6, further comprising transmitting the low level data over a network as data packets.

8. The method of claim 7, further comprising stopping recording data.

9. The method of claim 1, further comprising processing the low-level data such that the at least one virtual data packet simulates a plurality of users.

10. The method of claim 9, wherein processing the low-level data further comprises changing user identifiers or IP addresses.

11. The method of claim 9, further comprising analyzing network functionality based on a response of the network or of network components to the at least one virtual data packet.

12. A method for generating traffic data packets on a computer system in communication with a network, the method comprising:
instructing a computer program on the computer system to record subsequent network traffic data;
causing the computer system to create network traffic data packets comprised of low-level data, the low-level data being generated by the computer system in response to high-level data being input into the computer system;
recording the network traffic data packets transmitted over the network from the computer system; and
generating at least one virtual traffic data packet from the at least one data packet, each virtual traffic data packet being comprised of virtual data similar to the low-level data.

13. The method of claim 12, further comprising processing the at least one virtual traffic data to simulate a plurality of users;

14. The method of claim 13, further comprising transmitting the at least one virtual traffic data packet over a network.

15. The method of claim 14, further comprising monitoring the network with a protocol analyzer to analyze the at least one virtual traffic data packet and to analyze a response of the network or of network components to the at least one virtual traffic data packet.

16. A method for testing a website with generated traffic, the method comprising:
receiving input initiating a traffic generator;
accessing a website while the traffic generator is operating;
receiving high-level input from the user that corresponds to the user browsing the website;
recording low-level data that corresponds to network data that is generated from the high-level input; and
generating virtual network data for multiple virtual users based on the recorded low-level data; and
testing a functionality of the website based on the virtual network data.

17. The method of claim 16, further comprising generating virtual network data by changing user identifiers in the virtual network data.

18. The method of claim 17, wherein generating virtual network data comprises altering the low-level data for each virtual user so that the website appears to receive network data from the multiple virtual users simultaneously.

19. The method of claim 16, further comprising monitoring a response of the website to the virtual network data;

20. The method of claim 19, further comprising measuring responses to threads.

21. The method of claim 16, further comprising:
providing the recorded low-level data to a monitoring firm, wherein the monitoring firm generates the virtual network data to generate diagnostic data.

22. The method of claim 16, wherein the virtual network data represents traffic from multiple users to test how the website responds to multiple users using the website at the same time.

23. A method for generating traffic data packets on a computer system in communication with a network, the method comprising:
receiving a record instruction from a user, wherein the user has implemented the record instruction by at least one of selecting a user-selectable icon or filled-in a form-field;
recording at least one data packet transmitted over the network from the computer system, the at least one data packet being comprised of low-level data having a user identifier;
receiving a stop-record instruction from the user, wherein the user has implemented the stop-record instruction by at least one of selecting a user-selectable icon or filled-in a form-field;
terminating the recording of the network traffic data generated by the user; and
generating at least one virtual traffic data packet from the at least one data packet, each virtual traffic data packet being comprised of virtual data similar to the low-level data and having a virtual identifier different from the user identifier.
